(19) United States
(12) Patent Application Publication
(10) Pub. No.: US 2014/0111449 A1
(43) Pub. Date: Apr. 24, 2014

(54) DEVICE AND METHOD FOR EYES-FREE OPERATION OF TOUCH SURFACE

(71) Applicant: APACER TECHNOLOGY INC., New Taipei City (TW)

(72) Inventor: Yu-Hsuan Lee, New Taipei City (TW)

(73) Assignee: APACER TECHNOLOGY INC., New Taipei City (TW)

(21) Appl. No.: 13/846,616

(22) Filed: Mar. 18, 2013

(30) Foreign Application Priority Data
Oct. 19, 2012 (TW) 101138752
Oct. 19, 2012 (TW) 101138754

(51) Int. Cl. G06F 3/01

(52) U.S. Cl. CPC G06F 3/016
USPC 345/173; 345/102

(57) ABSTRACT

A tactile positioning device includes a film attached to a touch surface of a portable electronic device. The film includes at least a first tactile unit used as a positioning reference point of a key on the touch surface, and at least a second tactile unit being a linear tactile unit for defining an operating route or an operating range. The tactile feedbacks provided by the first tactile unit and the second tactile unit enable a user to sense a position of the key which is positioned by the first tactile unit and the operating route or the operating range defined by the second tactile unit, so as to operate the portable electronic device without having to look at the touch surface.

### FIELD OF THE INVENTION

The present invention relates to device and method for eyes-free operation of a touch surface, and more particularly to device and method for eyes-free operation of a touch screen.

### BACKGROUND OF THE INVENTION

Recently, the smart phone has become mainstream product in the market. As increased demand for smart phones in the market, a variety of smart phones are developed to have enhanced functions and provide more plentiful additional functionalities and App (application software) services so as to attract the attentions of the smart phone users.

Among the numerous Apps for the smart phone, more and more remote control Apps are developed by various developers. The remote control Apps can provide various exclusive remote control interfaces for various electronic devices and can be downloaded to the smart phone to transform the smart phone into a remote control for the electrical appliances such as TV, intelligent TV or multimedia player. Consequently, the smart phone user can switch the TV channels and adjust the volume freely, browse and operate the multifunctional selection menu on the display easily and quickly, and browse web pages and play games so as to achieve the intelligent demands.

In using these Apps on the smart phone for remote control, the signal transmission can be performed via the wireless communication network or the infrared transmitter of the smart phone and the remote control operation can be performed via the touch screen of the smart phone. Typically, the touch screen of the smart phone is a flat surface and can be operated by clicking the touch screen. Consequently, the user has to look at the keys displayed on the touch screen of the smart phone so as to click the target keys accurately to perform the remote control.

However, such operation methods are inconvenient for the user to operate the smart phone. For example, when the user looks at the display of the television and needs to switch the TV channels or adjust the volume, the user has to look at the touch screen of the smart phone so as to find out the target keys displayed on the touch screen of the smart phone to perform the remote control. As a result, the quality of television viewing is affected. For another example, when the user is playing a game, the user has to look at the keys displayed on the touch screen of the smart phone constantly. Consequently, the user can't concentrate on the game characters or targets, the game playing may be interfered during the game process, and the result of the game contest is affected.

In addition, for allowing the user to look at the keys displayed on the touch screen of the smart phone, the backlight module of the touch screen must be always turned on to display the virtual keys of remote control functions. In using these Apps on the smart phone for remote control, typical TV viewing time, internet browsing time, or gaming time may last from 30 minutes to several hours. Since the backlight module of the touch screen consumes a large portion of battery power, the battery power may drains away very quickly if the backlight module of the touch screen is always turned on. Consequently, the smart phone must be charged in very short time and may cause inconvenience to the user.

From the above, there is a need to make the smart phone as a remote control more user friendly, and avoid the rapid power-consuming problem.

### SUMMARY OF THE INVENTION

It is an object of the present invention to provide a tactile positioning device and an operating device having the tactile positioning device, so that the user can feel the position of the key on the touch surface of the operating device and operate the operating device in an eyes-free mode without having to look at the key on the touch surface of the operating device.

It is another object of the present invention to provide the method for controlling the backlight of the touch surface for eyes-free operation. To save battery power, the method first activates an eyes-free mode of an electronic device, e.g. by providing the tactile positioning device on the touch surface, so the backlight module of the touch surface can be turned off, and the utilization status is dynamically detected so as to turn on or adjust the brightness of the backlight module of the touch screen when needed.

In accordance with an aspect of the present invention, there is provided a tactile positioning device including a film attached to a touch surface of a portable electronic device. The film includes at least a first tactile unit used as a positioning reference point of a key on the touch surface, and at least a second tactile unit being a linear tactile unit for defining an operating route or an operating range. The tactile feedbacks provided by the first tactile unit and the second tactile unit enable a user to sense a position of the key which is positioned by the first tactile unit and the operating route or the operating range defined by the second tactile unit, so as to operate the portable electronic device without having to look at the touch surface.

In accordance with another aspect of the present invention, there is provided an operating device for eyes-free operation including a portable electronic device having a touch surface, and a tactile positioning device having at least a film attached to a partial range of the touch surface of the portable electronic device. The film includes at least a first tactile unit used as a positioning reference point of a key on the touch surface, wherein an edge of the film defines an operating route or an operating range, and a tactile feedback provided by the first tactile unit enables a user to sense a position of the key which is positioned by the first tactile unit and a tactile feedback provided by the edge of the film enables the user to sense the operating route or the operating range defined by the edge of the film, so as to operate the portable electronic device without having to look at the touch surface.

In accordance with an additional aspect of the present invention, there is provided an operating device for eyes-free operation having a touch surface for receiving a touch input, characterized in that a linear tactile unit corresponding to an operating route of the operating device is disposed on the touch surface.

In accordance with a further aspect of the present invention, there is provided an operating method for eyes-free operation. The operating method includes steps of: providing a tactile unit on a touch surface of an operating device, and the tactile unit being used as a positioning reference point of a key; programming the operating device to not to respond to a finger search for the tactile unit on the touch surface; and programming the operating device to respond to a touch operation on the key or surrounding keys after the tactile unit is positioned by the finger search.

In accordance with a further aspect of the present invention, there is provided a method for controlling a backlight of a touch screen for an electronic device for eyes-free operation. The method includes steps of: activating an eyes-free mode of the electronic device; detecting an inclined angle of the touch screen; and adjusting a brightness of the touch screen according to a predetermined relationship between the brightness and the inclined angle of the touch screen.

In accordance with a further aspect of the present invention, there is provided a method for controlling a backlight of a touch screen for an electronic device for eyes-free operation. The method includes steps of: activating an eyes-free mode of the electronic device; detecting an inclined angle of the touch screen; and adjusting a brightness of the touch screen according to a predetermined relationship between the brightness and the inclined angle of the touch screen.

The above contents of the present invention will become more readily apparent to those ordinarily skilled in the art after reviewing the following detailed description and accompanying drawings, in which:

### BRIEF DESCRIPTION OF THE DRAWINGS

FIG. 1 schematically illustrates the tactile positioning device according to a preferred embodiment of the present invention;

FIG. 2 schematically illustrates a partial cross-section view of the film according to an embodiment of the present invention;

FIGS. 3A and 3B schematically illustrate the film according to a first embodiment of the present invention;

FIGS. 4A and 4B schematically illustrate the film according to a second embodiment of the present invention;

FIGS. 5A and 5B schematically illustrate the film according to a third embodiment of the present invention;

FIGS. 6A and 6B schematically illustrate the film according to a fourth embodiment of the present invention;

FIGS. 7A and 7B schematically illustrate the film according to a fifth embodiment of the present invention;

FIG. 8 schematically illustrates the film according to a sixth embodiment of the present invention;

FIG. 9 schematically illustrates the film according to a seventh embodiment of the present invention;

FIG. 10 schematically illustrates the film according to an eighth embodiment of the present invention;

FIG. 11 schematically illustrates the film according to a ninth embodiment of the present invention;

FIG. 12 schematically illustrates the film according to a tenth embodiment of the present invention;

FIG. 13 schematically illustrates the film according to an eleventh embodiment of the present invention;

FIG. 14 schematically illustrates the tactile positioning device according to another embodiment of the present invention;

FIG. 15 shows the flow chart of the operating method according to an embodiment of the present invention;

FIG. 16 shows the flow chart of the method for controlling the backlight of the touch screen according to an embodiment of the present invention;

FIG. 17 shows the flow chart of the method for controlling the backlight of the touch screen according to an embodiment of the present invention;

FIG. 18 shows the flow chart of the method for controlling the backlight of the touch screen according to an embodiment of the present invention;

FIG. 19 shows the flow chart of the method for controlling the backlight of the touch screen according to an embodiment of the present invention;

FIG. 20 shows the flow chart of the method for controlling the backlight of the touch screen according to an embodiment of the present invention;

FIG. 21 shows the flow chart of the method for controlling the backlight of the touch screen according to an embodiment of the present invention;

FIG. 22 shows the flow chart of the method for controlling the backlight of the touch screen according to an embodiment of the present invention; and

FIG. 23 shows the flow chart of the method for controlling the backlight of the touch screen according to an embodiment of the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

The smart phone is rapidly developed to have more and more functions, and it is more and more popular to use the smart phone as a remote control. In order to allow the user to fix his/her eyes on the TV screen, other displays, or the toy or the electrical appliances remotely controlled by the smart phone without having to look at the keys on the touch screen of the smart phone when navigating menus or performing various operations using the smart phone, the present invention provides a tactile positioning device, which includes a film to be attached to the touch screen of the smart phone. There is at least one tactile unit disposed on the film to provide a feel of textures to the user when the user moves his/her finger on the touch screen, so that the user can feel the position of the key by his/her finger. Therefore, the user can operate the smart phone as a remote control in an eyes-free mode, i.e. without having to look at the keys on the touch screen of the smart phone, so as to have a more flexible utilization.

Certainly, the film can be applied to not only the smart phone, but also other portable electronic device, such as the tablet computer (or tablet PC), that also has a touch screen and can be installed with a remote control App for remotely controlling other electrical appliances. In addition, except being attached to the touch screen, the film can also be attached to touch panels having no screen or display. For example, the film can be attached to the touchpads of keyboards, remote controls or laptop computers without influencing the functions of the touchpads. In other words, the film of the present invention can be applied to any portable electronic devices which have touch surfaces.

On the other hand, the tactile positioning device of the present invention is not limited to provide the feel of texture through the film. For example, the tactile positioning device can be directly attached to the touch surfaces of the above-mentioned portable electronic devices and also have the same effects.

For convenience of illustration, the following embodiments are illustrated using the smart phone as the example of the portable electronic device and using the film as the example of the tactile positioning device.

According to the embodiment of the present invention, the film is optically clear, transparent or semi-transparent without interfering the viewing and operating of the touch screen of the smart phone, and can provide a protection to the touch screen without influencing the touch function of the smart phone. The film may have various sizes and shapes to facilitate placing the film on the touch screen according to the user's requirement.

The film is re-usable, removable, and re-attachable, so it can be removed from the touch screen when the user is not using the smart phone as a remote control, and re-attached to the touch screen when needed.

According to the embodiment of the present invention, the film includes one or more tactile unit for providing the user with different senses of touch. The tactile unit may be formed by a protrusion or an indentation, or may be any uneven or irregular surface, or may be formed by the material different from that of the other area of the film. Certainly, the present invention is not limited to the above-mentioned examples, and any other means to create texture differences between the tactile unit and the rest surface of the film so as to stimulate different senses of touch through user's fingertips can also be applied to the present invention.

Naturally, the shapes and forms of the tactile units are not limited. For example, the tactile unit may be in a shape of circle, ellipse, regular or irregular polygon, or may be in the form of line, character, symbol, pattern, or other decorative design.

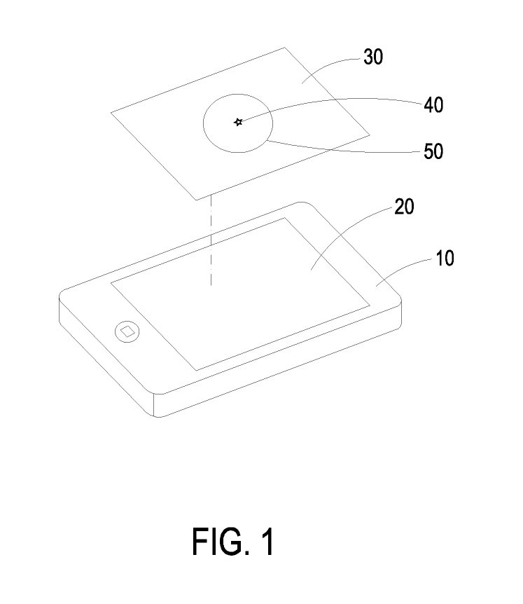

FIG. 1 schematically illustrates the tactile positioning device according to a preferred embodiment of the present invention. As shown in FIG. 1, the tactile positioning device includes a film 30 which is attached to the touch screen 20 of the smart phone 10. The film 30 includes at least one tactile unit; for example, the film 30 includes a first tactile unit 40 and a second tactile unit 50. The smart phone 10 can be installed with a remote control App which displays a remote control interface having at least one key on the touch screen 20. The first and second tactile units 40 and 50 enable the user to feel the positions of the major keys for operation. Therefore, the film 30 and the smart phone 10 constitute a remotely controlling device, such as a remote control.

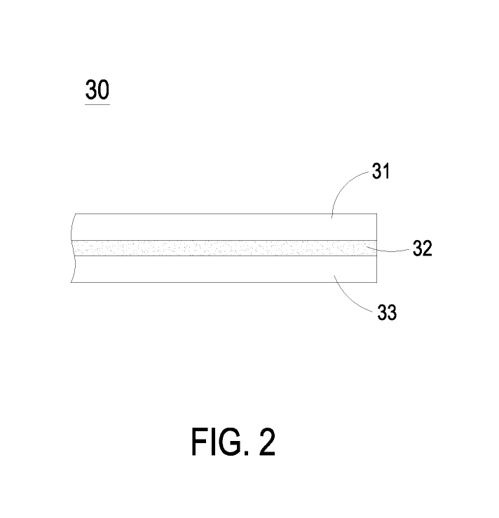

FIG. 2 schematically illustrates a partial cross-section view of the film according to an embodiment of the present invention. The film 30 includes, from top to bottom, a first layer 31, an adhesive layer 32 and a second layer 33. The adhesive layer 32 may be a glue layer to stick and combine the first layer 31 and the second layer 33. The bottom surface of the second layer 33 is an even surface and is attached to the touch screen 20 of the smart phone 10. The first tactile unit 40 and the second tactile unit 50 are disposed on the top surface of the first layer 31.

In an embodiment, the first layer 31 is but not limited to be integrally formed by heat-setting material or light-setting material. For example, the light-setting material is light-setting resin. The second layer 33 is a transparent membrane, such as formed by PET, PC, PVC or PP, but not limited thereto.

In an embodiment, the surface of the film is formed by glass material to provide a sense of touch similar to that of the touch screen of the smart phone.

According to the embodiment of the present invention, the amount and layout of the tactile units on the film can de designed based on the remote control interface of the installed App. The tactile units are disposed to be corresponding to the major keys of the remote control interface, so that the user can feel the positions of the major keys and according to the relative positions of the major keys and other keys, the user can perform the operations of these keys. Therefore, the tactile units can be provided only corresponding to the important or frequently used keys, so it is not necessary to provide the tactile units to correspond to all the keys on the touch screen.

In an embodiment, the tactile unit may be designed as a linear tactile unit so as to define an operating route of the key for guiding the user's finger to slide along the route indication of the linear tactile unit. Alternatively, the linear tactile unit may be used to define the operating range or boundary.

Certainly, the film of the present invention can be selectively attached to an entire range of the touch screen, or attached to a partial range of the touch screen according to different requirements.

The following embodiments are illustrated with different layouts of the tactile units on the film according to different remote control interfaces. It is to be noted that the following embodiments are presented for purpose of illustration and description only. Other extended designs modified from the present invention are also included in the protective scope of the present invention.

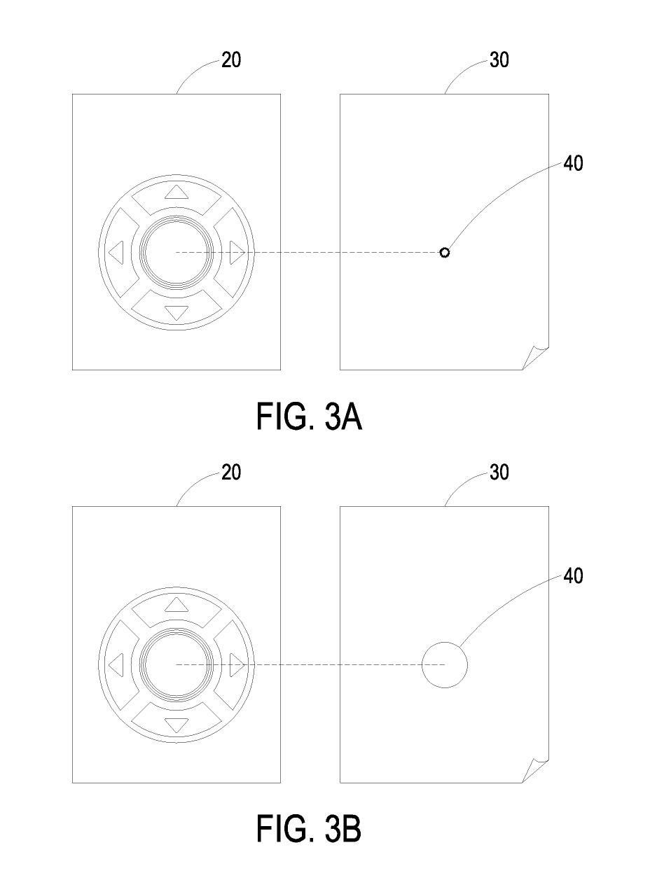

FIGS. 3A and 3B schematically illustrate the film according to a first embodiment of the present invention. The remote control interface displayed on the touch screen 20 is a 5-way navigation pad including UP, DOWN, LEFT and RIGHT keys, and the central ENTER key. A first tactile unit 40 is disposed on the film 30 and corresponding to the central ENTER key. When the user feels the position of the first tactile unit 40, the positions of the ENTER key and the surrounding UP, DOWN, LEFT and RIGHT keys are thus known to the user, so the user can operate the remote control in the eyes-free mode.

The size and the shape of the tactile area formed by the first tactile unit 40 are not limited. For example, the first tactile unit 40 shown in FIG. 3A is a protrusion point, and the first tactile unit 40 shown in FIG. 3B is a circle having larger tactile area and the center of the circle is corresponding to the center of the ENTER key. The size and the shape of the tactile area can be varied depending on the corresponding 5-way navigation pad and/or the size of user's finger operating on top of the film. When the tactile area is formed as a small point, it owns a benefit that the interferences to the viewing and operating of the touch screen are greatly reduced.

In the input mode of “release to enter”, when the central ENTER key is to be input, the user's finger (e.g. thumb) can first touch any point on the touch screen, move the finger without leaving the touch screen to search or feel the tactile unit, and finally untouch or move the finger out of the touch screen at the location of the tactile unit to input the ENTER key.

Similarly, to input the RIGHT key, the user's finger can first touch any point on the touch screen, move the finger without leaving the touch screen to search or feel the tactile unit, keep moving to the right of the tactile unit, and finally untouch or move the finger out of the touch screen at the location appropriately right to the tactile unit to input the RIGHT key.

The “release to enter” input mode allows the user's finger to linger on the surface of the touch screen in search of the tactile feedback without accidentally clicking to input.

In the input mode of “single click to enter”, the remote control App is programmed to make a difference between finger click and finger search. A click is a click in traditional sense where the contact time between the finger and the touch screen lasts for a very short period of time. A finger search is a prolonged click that may last, for example, over 0.5 second, and the finger moves on the touch screen but not contact the touch screen at a fixed point. Thus the remote control App can tell whether the user is clicking or searching for the tactile unit. When the user feels the tactile unit, the user's finger can untouch or move the finger out of the touch screen, and then single click at the location of the corresponding key for input.

Similarly, in the input mode of “double click to enter”, when the user feels the tactile unit, the user's finger can untouch or move the finger out of the touch screen, and then double click at the location of the corresponding key for input.

In this embodiment, the first tactile unit 40 and the ENTER key are in an exactly corresponding relationship, i.e. the location of the first tactile unit 40 is the location of the ENTER key. In other embodiments, the tactile unit may not be exactly corresponding to the key but disposed adjacent to the key to be as a positioning reference point. For example, the remote control interface shown in FIGS. 3A and 3B may also be a remote control interface only have the UP, DOWN, LEFT and RIGHT keys, and the center is not functioned as a key. In other words, the center position where the first tactile unit 40 is disposed is not corresponding to any key, but can be used as a positioning reference point of the UP, DOWN, LEFT and RIGHT keys. When the user feels the position of the first tactile unit 40, the positions of the UP, DOWN, LEFT and RIGHT keys can also be aware, so the user can operate the remote control in the eyes-free mode.

In brief, the present invention is to provide a tactile unit on a touch surface of an operating device, wherein the tactile unit may be but not limited to a point tactile unit. The tactile unit is used as a positioning reference point of a key set including at least one key of the operating device. The operating device is programmed to not to respond to user's finger search for the tactile unit on the touch surface, and respond to a touch operation on the key set after the tactile unit is positioned by the finger search.

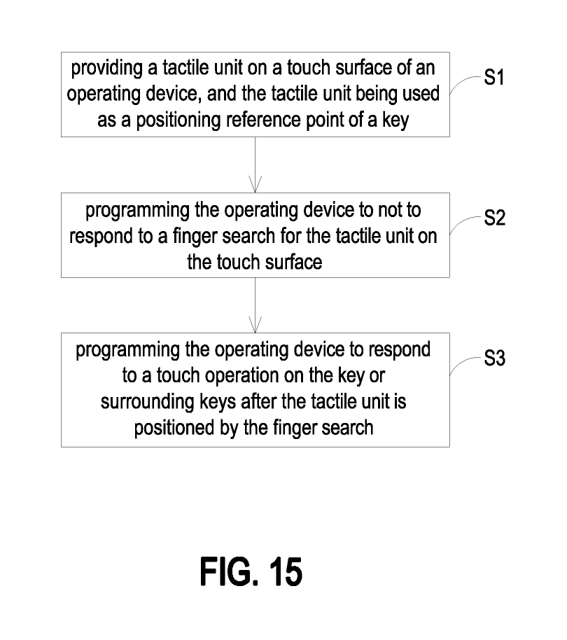

In other words, the present invention also provides an operating method. As shown in FIG. 15, the operating method including steps of: providing a tactile unit on a touch surface of an operating device, wherein the tactile unit is used as a positioning reference point of a key (S1); programming the operating device to not to respond to user's finger search for the tactile unit on the touch surface (S2); and programming the operating device to respond to a touch operation on the key or surrounding keys after the tactile unit is positioned by the finger search (S3). In this embodiment, the operating device is programmed to not to respond to the user's finger search with a contact time lasting over a predetermined time, for example, over 0.5 second.

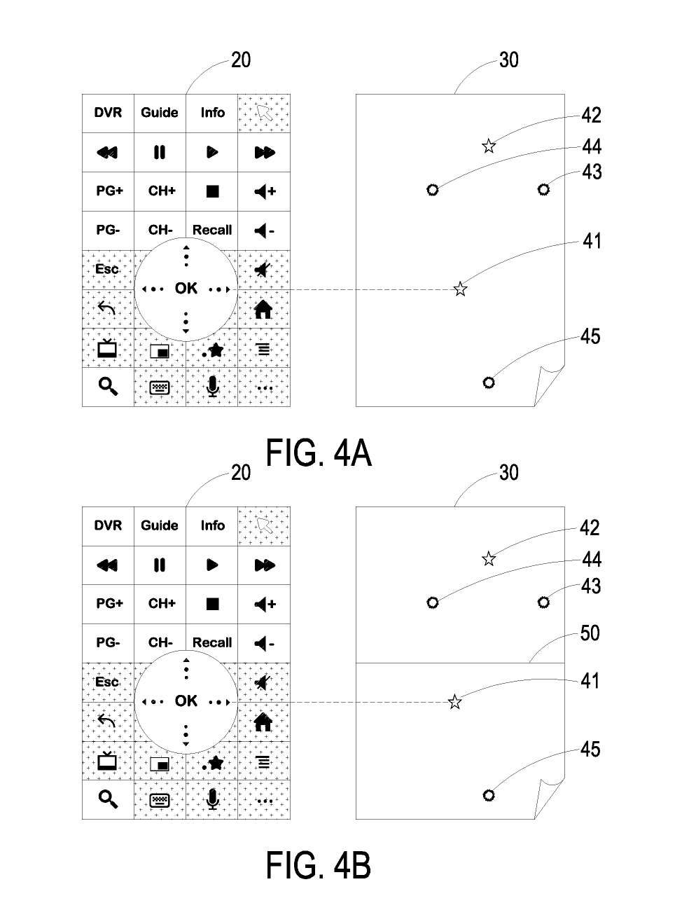

FIGS. 4A and 4B schematically illustrate the film according to a second embodiment of the present invention. The remote control interface displayed on the touch screen 20 is Google TV remote control interface. The film 30 includes plural first tactile units 41, 42, 43, 44 and 45 which are corresponding to OK, PLAY, VOLUME UP, CHANNEL UP, and VOICE CONTROL keys, respectively. In addition, nearby tactile units may have different surface textures (shown by different symbols in FIGS. 4A and 4B). For example, nearby tactile units may have different shapes or forms for stimulating different tactile senses to user in order to facilitate differentiation and avoid confusion. This is useful when the tactile units are too close together or when the user's finger is too big.

As shown in FIG. 4B, the film 30 further includes a second tactile unit 50, which is a linear tactile unit for dividing the touch screen 20 into upper control area and lower control area. The user can feel when his/her finger crosses the boundary defined by the second tactile unit 50 for controlling different operation modes or programs.

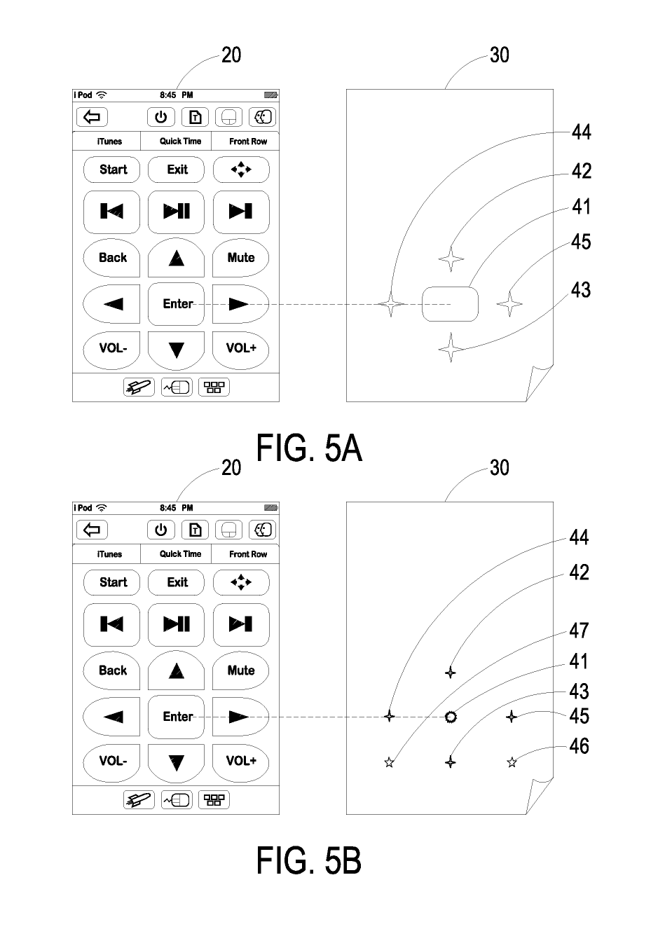

FIGS. 5A and 5B schematically illustrate the film according to a third embodiment of the present invention. According to the remote control interface displayed on the touch screen 20, the film 30 includes plural first tactile units 41, 42, 43, 44 and 45 which are corresponding to the central ENTER key, and the UP, DOWN, LEFT and RIGHT keys, respectively. The UP, DOWN, LEFT and RIGHT keys have the surface textures different from that of the central ENTER key (shown by different symbols in FIGS. 5A and 5B). For example, they may have different shapes or forms for stimulating different tactile senses to user in order to facilitate differentiation and avoid confusion, so the user can operate the remote control in the eyes-free mode.

Certainly, the tactile areas formed by the first tactile units 41, 42, 43, 44 and 45 can be varied according to different requirements, as shown in FIGS. 5A and 5B. Moreover, as shown in FIG. 5B, the film 30 further includes the first tactile units 46 and 47 which are corresponding to VOLUME UP and VOLUME DOWN keys, respectively. Similarly, the first tactile units 46 and 47 may have the surface textures different from those of the other first tactile units 41, 42, 43, 44 and 45 in order to facilitate differentiation and avoid confusion.

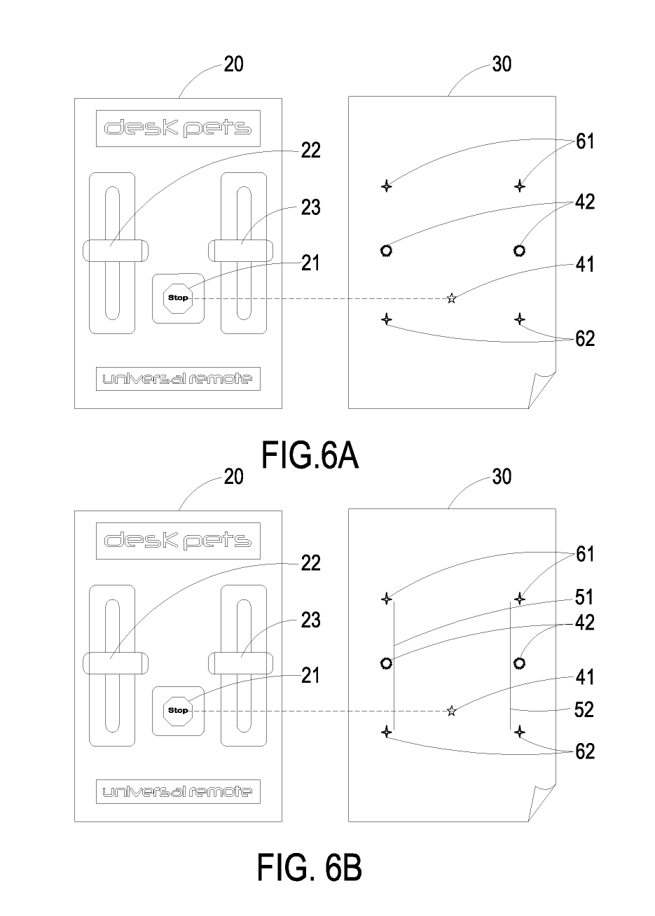

FIGS. 6A and 6B schematically illustrate the film according to a fourth embodiment of the present invention. Tankbot is a toy tank developed by Desk Pets. The moving and turning of the toy tank can be remotely controlled, and the user can install the remote control App to the smart phone. As shown in FIGS. 6A and 6B, the touch screen 20 displays the Tankbot remote control interface for iPhone, which includes the STOP key 21, the left stick 22 and the right stick 23. The left stick 22 is for controlling the left track of the toy tank in forward and backward motion, and the right stick 23 is for controlling the right track of the toy tank in forward and backward motion.

As shown in FIG. 6A, the film 30 includes a first tactile unit 41 corresponding to the STOP key 21, two first tactile units 42 corresponding to start points (i.e. neutral points) of the left and right sticks 22 and 23, two third tactile units 61 corresponding to forward end points of the left and right sticks 22 and 23, and two third tactile units 62 corresponding to backward end points of the left and right sticks 22 and 23. Therefore, by means of the first tactile units 41 and 42 and the third tactile units 61 and 62, the user can operate the remote control in the eyes-free mode, and thus the user can fix his/her eyes on the toy tank so as to flexibly control the moving and turning of the toy tank.

Compared to FIG. 6A, the film 30 shown in FIG. 6B further includes two second tactile units 51 and 52, which are linear tactile units disposed on forward and backward operating routes of the left and right sticks 22 and 23 for guiding the user's finger to slide along the route indication of the second tactile units 51 and 52 without leaving the touch control area, so that the moving and turning of the toy tank can be effectively controlled.

In an embodiment, the linear tactile unit may also be formed by discontinuous lines. In another embodiment, the linear tactile unit may be formed by a band area having a certain width. However, when the linear tactile unit is formed as a thin line, it owns a benefit that the interferences to the viewing and operating of the touch screen are greatly reduced.

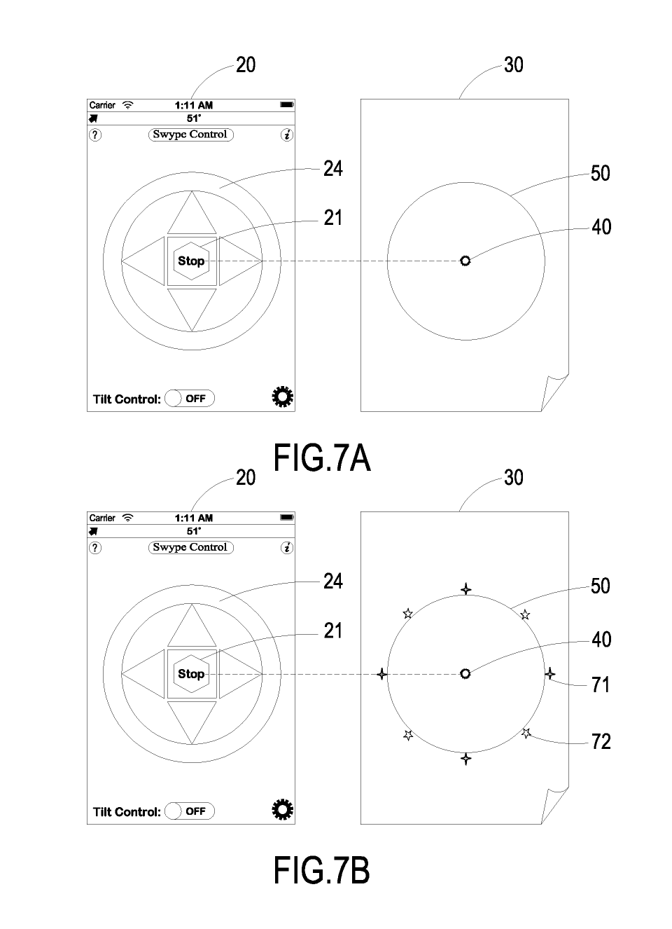

FIGS. 7A and 7B schematically illustrate the film according to a fifth embodiment of the present invention. In addition to the central STOP key 21 and the surrounding UP, DOWN, LEFT and RIGHT keys, the remote control interface displayed on the touch screen 20 further includes a control wheel 24 used to control various tasks in a continuous way, such as direction control, speaker volume, scrolling up/down menu, etc. While on the film 30, except the first tactile unit 40 corresponding to the central STOP key, the film 30 further includes a second tactile unit 50 which is a linear tactile unit disposed above the control wheel 24 to define the ring-shaped operating route of the control wheel 24 for guiding the user's finger to perform the continuous operation along the second tactile unit 50.

In addition to the first and second tactile units 40 and 50, the film 30 shown in FIG. 7B further includes plural fourth tactile units 71 and 72 disposed on the operating route defined by the second tactile unit 50. The plural fourth tactile units 71 and 72 may be disposed at the surrounding of the second tactile unit 50 and quite close to the second tactile unit 50, and include a set of four fourth tactile units 71 illustrated with cross symbols and a set of four fourth tactile units 72 illustrated with star symbols, all of which are disposed on the equal division points of the operating route defined by the second tactile unit 50. For example, the four fourth tactile units 71 illustrated with cross symbols are disposed on 0, 90, 180, 270 degrees of the ring, while the four fourth tactile units 72 illustrated with star symbols are disposed on 45, 135, 225, 315 degrees of the ring. The positioning function provided by the plural fourth tactile units 71 and 72 facilitates the user feeling the relative positions of the finger on the operating route, so as to assist the operation of the control wheel 24.

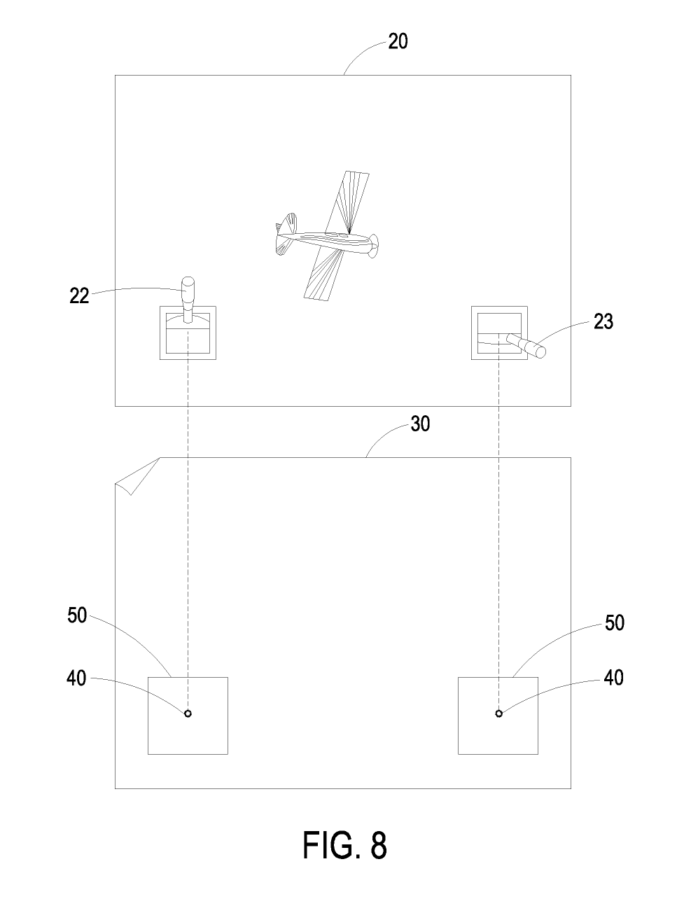

FIG. 8 schematically illustrates the film according to a sixth embodiment of the present invention. The touch screen 20 displays a remote control interface for a RC flight stimulator having a left stick 22 and a right stick 23. The user usually uses both thumbs to control throttle, rudder, elevator, and aileron of the airplane through the left and right sticks 22 and 23. Each of the sticks 22 and 23 has a neutral point and two end points in both the up/down direction and the right/left direction. The film 30 includes two first tactile units 40 respectively corresponding to the two neutral points of the two sticks 22 and 23, and two second tactile units 50 enclosing the two first tactile units 40 respectively. The second tactile units 50 are linear tactile units to define the rectangle-shaped operating ranges of the two sticks 22 and 23.

By appropriately matching the tactile rectangles to exactly the stick control areas on the touch screen 20, the first tactile units 40 assist the user to precisely return the sticks 22 and 23 to neutral points, while the second tactile units 50 provide tactile feedback in such a way that the user can feel whether the sticks 22 and 23 are at their end points, meaning whether the throttle is up to maximum, whether the rudder is right to maximum, whether the elevator is down to maximum, and whether the aileron is left to maximum. Without the first tactile units 40 and the second tactile units 50, the user has to move his/her eyes from the airplane to the sticks 22 and 23 to see what positions the sticks 22 and 23 are in, but the two thumbs always are on top of the sticks 22 and 23 so it is difficult to see clearly what their positions are. Therefore, under the assistance of the film 30 with the first tactile units 40 and the second tactile units 50, the user can easily feel the neutrals and the boundary of the operating ranges of the sticks 22 and 23 by his/her thumbs, and operate the remote control in the eyes-free mode, and thus the user can fix his/her eyes on the airplane so as to flexibly operate the airplane.

In the above embodiments, the film 30 is attached on the entire range of the touch screen. Alternatively, the film 30 can also be selectively attached on a partial range of the touch screen, and the followings are some examples.

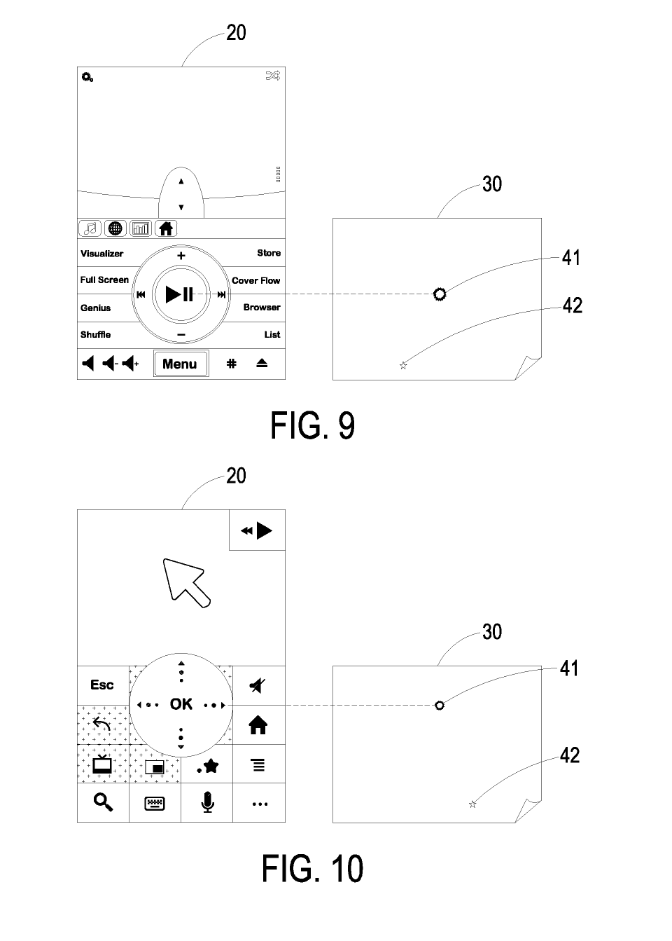

FIG. 9 schematically illustrates the film according to a seventh embodiment of the present invention. The touch screen 20 displays a remote control interface for Mobile Mouse Pro including upper part and lower part, wherein the upper part is reserved for trackpad use, and the lower part includes plural control keys. Only the lower part of the touch screen 20 is covered by the film 30, and the film 30 includes plural first tactile units 41 and 42 which are corresponding to PLAY/PAUSE key and VOLUME UP key, respectively. In this embodiment, the upper edge of the film 30 forms a natural boundary, which is served as a linear tactile unit dividing the touch screen 20 into upper and lower parts, and the user can feel the lower limit of the trackpad operating range when his/her finger touches the upper edge of the film 30. Therefore, except forming tactile units on the film 30 for finger positioning of the keys on the touch screen 20, the edge of the film 30 can also provide tactile feedback to the user to feel the boundary of the operating range, which enables a more flexible operation.

FIG. 10 schematically illustrates the film according to an eighth embodiment of the present invention. The touch screen 20 displays a remote control interface for Google TV including upper part and lower part, wherein the upper part is reserved for trackpad use, and the lower part includes plural control keys. Only the lower part of the touch screen 20 is covered by the film 30, and the film 30 includes plural first tactile units 41 and 42 which are corresponding to OK key and VOICE CONTROL key, respectively. Similarly, the upper edge of the film 30 forms a natural boundary, which is served as a linear tactile unit dividing the touch screen 20 into upper and lower parts, and the user can feel the lower limit of the trackpad operating range when his/her finger touches the upper edge of the film 30. Therefore, except forming tactile units on the film 30 for finger positioning of the keys on the touch screen 20, the edge of the film 30 can also provide tactile feedback to the user to feel the boundary of the operating range, which enables a more flexible operation.

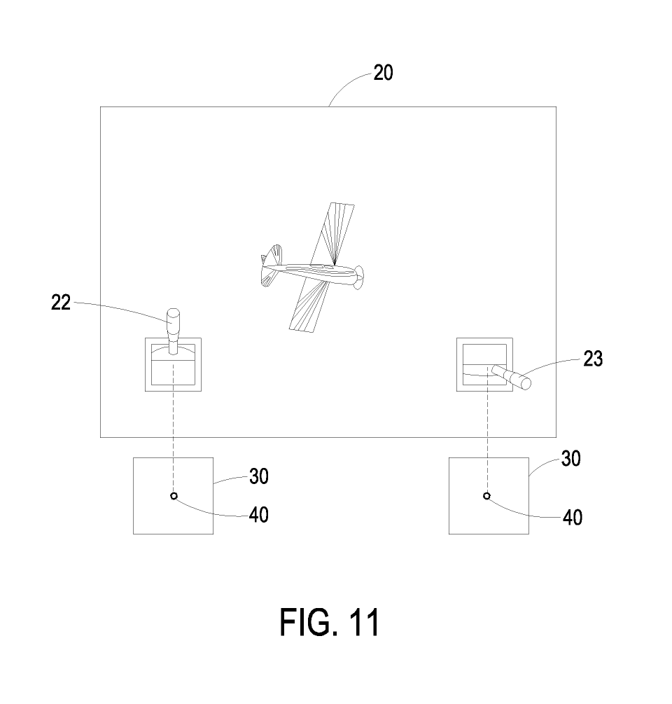

FIG. 11 schematically illustrates the film according to a ninth embodiment of the present invention. The touch screen 20 displays a remote control interface for a RC flight stimulator having a left stick 22 and a right stick 23. The user usually uses both thumbs to control throttle, rudder, elevator, and aileron of the airplane through the left and right sticks 22 and 23. Each of the sticks 22 and 23 has a neutral point and two end points in both the up/down direction and the right/left direction. In this embodiment, two rectangular films 30 are attached to the touch screen 20 and corresponding to the operating ranges of the two sticks 22 and 23. Each film 30 includes a first tactile unit 40 corresponding to the neutral point of the stick 22 or 23. The area enclosed by the rectangular film 30 is the operating range of the stick 22 or 23, so the four edges of the rectangular film 30 are served as a linear tactile unit to indicate the ends of the operating range.

By appropriately matching the rectangular films to exactly the stick control areas on the touch screen 20, the first tactile units 40 assist the user to precisely return the sticks 22 and 23 to neutral points, while the four edges of the rectangular film 30 provide tactile feedbacks in such a way that the user can feel whether the sticks 22 and 23 are at their end points, meaning whether the throttle is up to maximum, whether the rudder is right to maximum, whether the elevator is down to maximum, and whether the aileron is left to maximum. Without the films 30 and first tactile units 40, the user has to move his/her eyes from the airplane to the sticks 22 and 23 to see what positions the sticks 22 and 23 are in, but the two thumbs always are on top of the sticks 22 and 23 so it is difficult to see clearly what their positions are. Therefore, under the assistance of the films 30 with the first tactile units 40, the user can easily feel the neutrals and the boundary of the operating ranges of the sticks 22 and 23 by his/her thumbs, and operate the remote control in the eyes-free mode, and thus the user can fix his/her eyes on the airplane so as to flexibly operate the airplane.

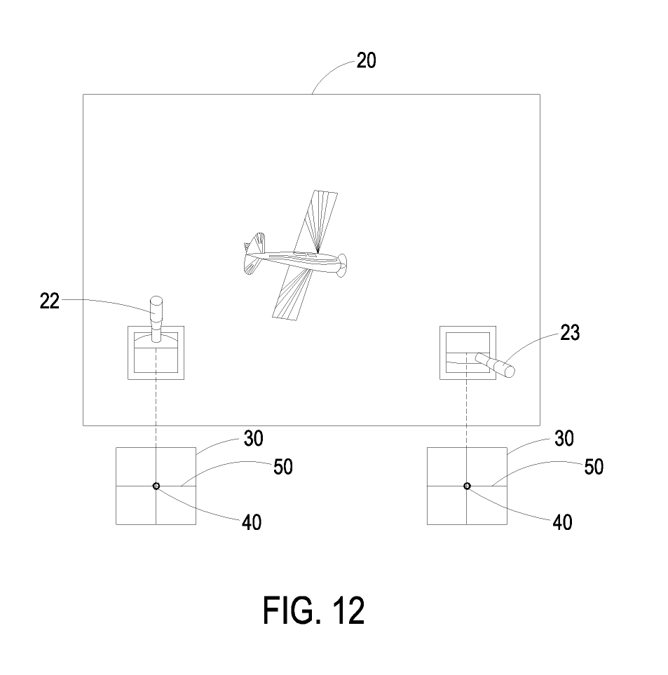

FIG. 12 schematically illustrates the film according to a tenth embodiment of the present invention. Compared to FIG. 11, the film 30 of this embodiment further includes a second tactile unit 50, which is a cross-shaped linear tactile unit having horizontal and vertical lines crossing at the first tactile unit 40 and respectively defining the up/down operating route and the right/left operating route of the stick 22 or 23 for guiding the user's finger to slide along the route indication of the second tactile unit 50, so that the control can be achieved more precisely without leaving the operating routes.

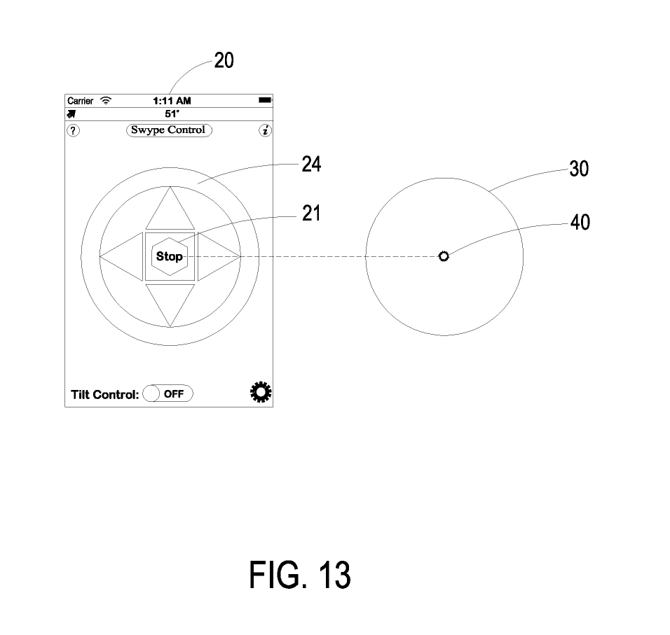

FIG. 13 schematically illustrates the film according to an eleventh embodiment of the present invention. In addition to the central STOP key 21 and the surrounding UP, DOWN, LEFT and RIGHT keys, the remote control interface displayed on the touch screen 20 further includes a control wheel 24 used to control various tasks in a continuous way, such as direction control, speaker volume, scrolling up/down menu, etc. While on the film 30, a first tactile unit 40 corresponding to the central STOP key is provided. Particularly, the film 30 is shaped as a circle, and the edge thereof is corresponding to the operating route of the control wheel 24 for guiding the user's finger to perform the continuous operation along the edge of the film 30.

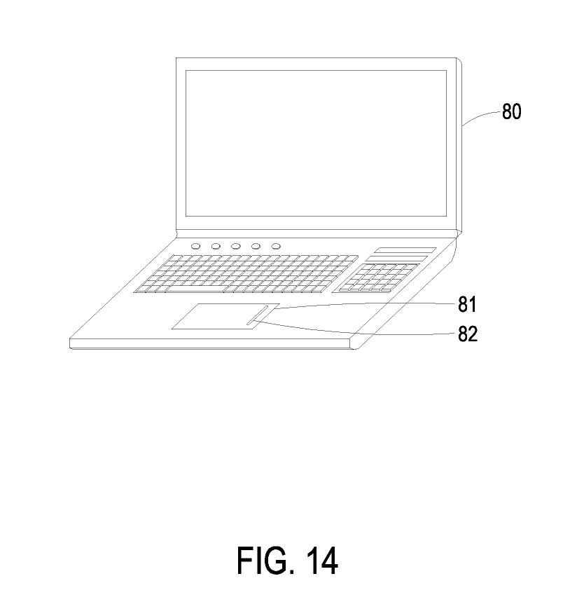

FIG. 14 schematically illustrates the tactile positioning device according to another embodiment of the present invention. The tactile positioning device includes at least one tactile unit 82, which is directly disposed on the touch surface, such as the touchpad 81 of the laptop computer 80. The tactile unit 82 is a linear tactile unit corresponding to the operating route of the touchpad 81 of the laptop computer 80 for guiding the user's finger to slide along the tactile unit 82. For example, when the user moves his/her finger forward or backward along the tactile unit 82, it may control scrolling up and down of the webpage or document shown on the computer display, so the user can perform the operations in the eyes-free mode.

In this and other embodiments, the tactile unit of the tactile positioning device can also be directly disposed on the touch surface of the portable electronic device without the use of the film, and the tactile unit does not have to be corresponding to the key on the touch surface. The tactile unit may be disposed on the touch surface by means of engagement, gluing or static electricity, or integrally formed with the touch surface. For example, the tactile point or tactile line may be directly formed on the glass or plastic material of the touch surface.

In this embodiment, the object which is operated through the tactile sense provided by the tactile unit is the webpage or document shown on the computer display, so the tactile unit is not limited to be used in remote control mode. Besides, the RC flight stimulator shown in FIG. 8 may also be played on the touch screen directly but not projected to the TV or other big screen, and under this situation, the operation does not belong to remote control mode, either.

Furthermore, by means of the tactile positioning device, the user can operate the smart phone as a remote control in an eyes-free mode, i.e. without having to look at the keys on the touch screen of the smart phone. In other words, the eyes-free mode of the touch screen is activated, and under the eyes-free mode, the battery power of the smart phone can be greatly saved. Therefore, the remote control App can further intelligently dim the touch screen to save power but simultaneously receive user's touch inputs.

Accordingly, as an extended application of the tactile positioning device, the present invention also provides a method for controlling the backlight of the touch screen, so as to turn off the backlight module of the touch screen in the eyes-free mode and turn on the backlight module of the touch screen again when the user needs to look at the touch screen.

Certainly, the method for controlling the backlight of the touch screen is not limited to be applied to the smart phone, and it can also be applied to other portable electronic device, such as the tablet computer (or tablet PC), that also has a touch screen and can be installed with a remote control App for remotely controlling other electrical appliances. In addition, the method for controlling the backlight of the touch screen is not limited to be applied to the portable electronic device used as a remote control, and except the remote control App, the method for controlling the backlight of the touch screen can also be applied to other Apps or operating modes.

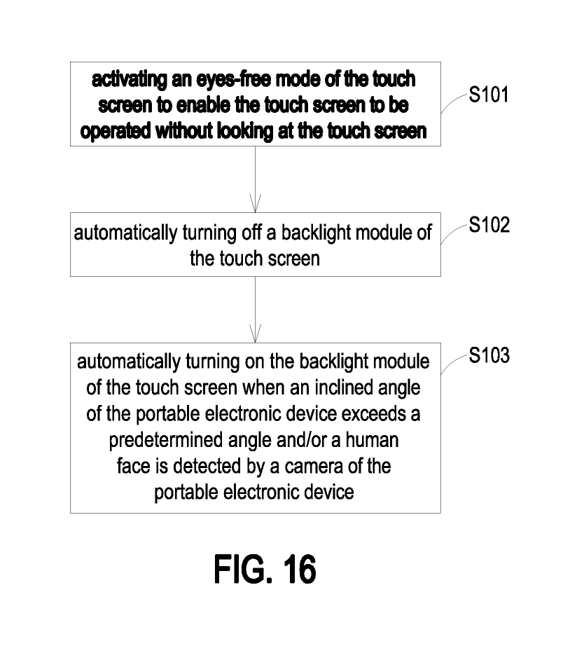

FIG. 16 shows the flow chart of the method for controlling the backlight of the touch screen according to an embodiment of the present invention. The method for controlling the backlight of the touch screen includes steps of: (a) activating an eyes-free mode of the touch screen to enable the touch screen to be operated without looking at the touch screen (S101); (b) automatically turning off the backlight module of the touch screen (S102); and (c) automatically turning on the backlight module of the touch screen when an inclined angle of the portable electronic device reaches a predetermined angle and/or a human face is detected by a camera of the portable electronic device (S103).

In an embodiment, to activate the eyes-free mode of the touch screen, a tactile positioning device is disposed on the touch screen of the portable electronic device. The tactile positioning device includes a film to be attached to the touch screen of the portable electronic device. There is at least one tactile unit disposed on the film and corresponding to position of the major key to provide a feel of textures to the user when the user moves his/her finger on the touch screen, so that the user can feel the position of the major key by his/her finger. Therefore, the user can operate the portable electronic device as a remote control without having to look at the keys on the touch screen of the smart phone, so the eyes-free mode the portable electronic device is activated. Under the eyes-free mode, the backlight module of the touch screen can be tuned off, and thus the battery power can be greatly saved.

In the above embodiments of the various films, if the remote control App is complicated, the film can only assist the user to operate some major or most-wanted functions under the eyes-free mode. There is still a need for the user to look into the touch screen for operations of the control keys without tactile feedback, or other information displayed on the touch screen. Therefore, it is needed to have a way to intelligently dim the screen for eyes-free operation, and to brighten up the screen for non-eyes-free operation.

For convenience of illustration, the following embodiments are illustrated using the smart phone as the example of the portable electronic device.

In an embodiment, the backlight module of the touch screen can be turned off (DISPLAY OFF) when the smart phone is placed in horizontal position (SCREEN DOWN) and/or when the smart phone camera detects no human face looking into the touch screen of the smart phone (FACE OFF), which is considered that the user can operate the remote control in the eyes-free mode or the remote control is temporarily not being used; and the backlight module of the touch screen can be turned on (DISPLAY ON) when an inclined angle of the smart phone reaches a predetermined angle (SCREEN UP) and/or a human face is detected by the smart phone camera (FACE ON), which is considered that the user has to look into the touch screen for operations.

In an embodiment, the inclined angle of the smart phone can be detected by a G sensor. According to the user's habits, SCREEN DOWN may represent the smart phone is in ±5 or ±10 degrees relative to the horizontal, and SCREEN UP may represent the smart phone is in 30-60 degrees relative to the horizontal. Besides, the human face is detected by the camera of the smart phone using a face recognition algorithm, and the camera is preferably a digital camera, such as CMOS camera, CCD camera or other digital cameras.

According to the method of the present invention, the backlight module of the touch screen of the smart phone can be automatically turned off under eyes-free mode, and automatically turned on when needed, and thus, the user does not need to tap or touch an icon to wake up the screen and bring up another menu or control keys. In other words, the user just “holds up the smart phone” and/or “looks into the screen” and everything is there again.

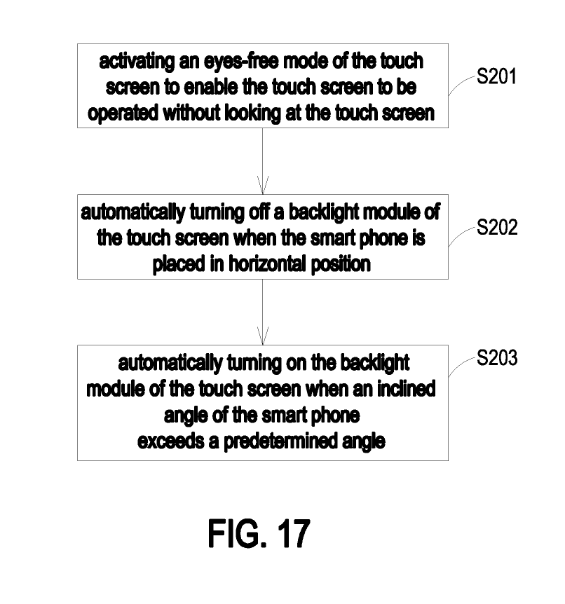

FIG. 17 shows the flow chart of the method for controlling the backlight of the touch screen according to an embodiment of the present invention. Typically, when using the smart phone as the remote control in the eyes-free mode, the user may hold the smart phone horizontally in his/her hand with the touch screen facing upward (SCREEN DOWN). When the user needs to look at the touch screen, the smart phone will be held vertically in front of user's face with the touch screen facing toward the user's face (SCREEN UP). Thus, the remote control App can be programmed to automatically turn off the backlight module of the touch screen when the smart phone is SCREEN DOWN, and turn on the backlight module of the touch screen of the smart phone when the smart phone is SCREEN UP, so as to save the battery power.

In other words, the method for controlling the backlight of the touch screen includes steps of: (a) activating an eyes-free mode of the touch screen to enable the touch screen to be operated without looking at the touch screen (S201); (b) automatically turning off the backlight module of the touch screen when the smart phone is placed in horizontal position (S202); and (c) automatically turning on the backlight module of the touch screen when an inclined angle of the smart phone reaches a predetermined angle (S203), and automatically turning off the backlight module of the touch screen again when the smart phone is placed in horizontal position.

The orientation/inclination of the smart phone in SCREEN DOWN and SCREEN UP can be customizable/configurable to fit the user's habits in holding the smart phone. For example, the inclined angle for SCREEN UP can be set to 30 degree, so holding up the smart phone to the user's face in slightly upward position will automatically turn on the backlight module of the touch screen. Whether the smart phone is in portrait mode or landscape mode, the setting can also be customizable and configurable.

In another embodiment, the inclined angle for SCREEN DOWN and SCREEN UP can be customizable/configurable according to the relative orientation and position between the controlled object and the user, or the facing direction of the user. For example, when the user projects the image on the ceiling to play a video through a media player, the user is in lying position for watching the image on the ceiling and holds the smart phone to remotely control the media player. In this situation, the setting of the inclined angle shall be different from that when the user is sitting on the sofa in the living room.

In addition, the time lag between the time when SCREEN UP/DOWN is detected and the time when DISPLAY ON/OFF is switched can also be customized and configured. For example, the remote control App can be configured to switch DISPLAY OFF after 3 seconds when SCREEN DOWN is detected. Certainly, the time lag can be varied according to different requirements, and it may be 2 to 5 seconds for instance. In order to wake up the screen as soon as possible, the remote control App can be configured to switch DISPLAY ON immediately when SCREEN UP is detected.

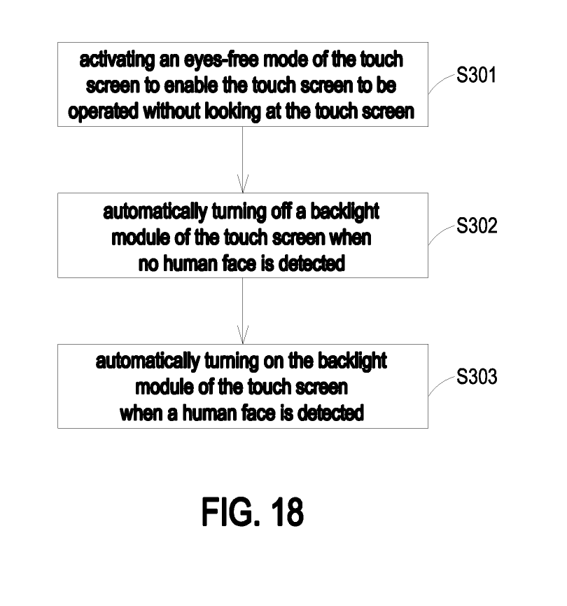

FIG. 18 shows the flow chart of the method for controlling the backlight of the touch screen according to an embodiment of the present invention. The remote control App can be programmed to detect whether the user is looking into the touch screen of the smart phone using face recognition algorithm to analyze images captured via the smart phone camera. When the user is not looking into the touch screen of the smart phone (FACE OFF), the backlight module of the touch screen is automatically turned off. When the user is looking into the touch screen of the smart phone (FACE ON), the backlight module of the touch screen is automatically turned on.

In other words, the method for controlling the backlight of the touch screen includes steps of: (a) activating an eyes-free mode of the touch screen to enable the touch screen to be operated without looking at the touch screen (S301); (b) automatically turning off the backlight module of the touch screen when no human face is detected (S302); and (c) automatically turning on the backlight module of the touch screen when a human face is detected (S303), and automatically turning off the backlight module of the touch screen again when no human face is detected.

The remote control App can be programmed to recognize the user's face by analyzing face contour, relative sizes and positions of eyes, eye brows, nose, mouse, ears, etc., or any other features in the captured images.

Moreover, the remote control App can be programmed to recognize different users' faces, so different profile settings, customized configurations, or favorite key layouts of the remote control can be loaded automatically without user intervention. Therefore, the method for controlling the backlight of the touch screen includes steps of: identifying the user when a human face is detected; and loading the customized settings based on the identification of the user.

Similarly, the time lag between the time when FACE ON/OFF is detected and the time when DISPLAY ON/OFF is switched can also be customized and configured. For example, the remote control App can be configured to switch DISPLAY OFF after 2 seconds when FACE OFF is detected. Certainly, the time lag can be varied according to different requirements, and it may be 2 to 5 seconds for instance. In order to wake up the screen as soon as possible, the remote control App can be configured to switch DISPLAY ON immediately when FACE ON is detected.

To more accurately determine whether the user intends to see the icons, keys, or any other information displayed on the touch screen of the smart phone, detections of SCREEN DOWN/UP and FACE ON/OFF can be activated simultaneously in various ways.

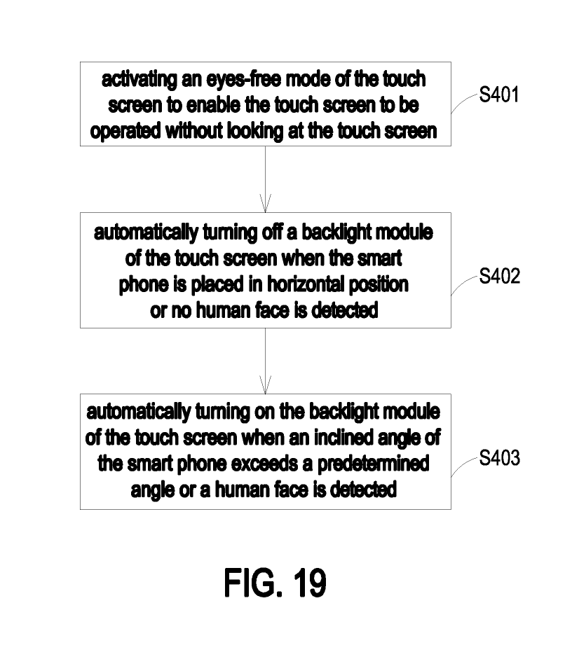

In an embodiment, as shown in FIG. 19, the method for controlling the backlight of the touch screen includes steps of: (a) activating an eyes-free mode of the touch screen to enable the touch screen to be operated without looking at the touch screen (S401); (b) automatically turning off the backlight module of the touch screen when the smart phone is placed in horizontal position or no human face is detected (S402); and (c) automatically turning on the backlight module of the touch screen when an inclined angle of the smart phone reaches a predetermined angle or a human face is detected (S403), and automatically turning off the backlight module of the touch screen again when the smart phone is placed in horizontal position or no human face is detected.

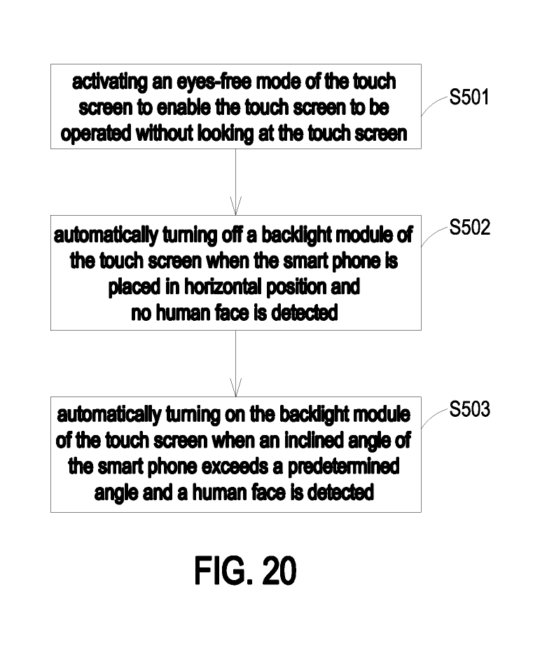

In an embodiment, as shown in FIG. 20, the method for controlling the backlight of the touch screen includes steps of: (a) activating an eyes-free mode of the touch screen to enable the touch screen to be operated without looking at the touch screen (S501); (b) automatically turning off the backlight module of the touch screen when the smart phone is placed in horizontal position and no human face is detected (S502); and (c) automatically turning on the backlight module of the touch screen when an inclined angle of the smart phone reaches a predetermined angle and a human face is detected (S503), and automatically turning off the backlight module of the touch screen again when the smart phone is placed in horizontal position and no human face is detected.

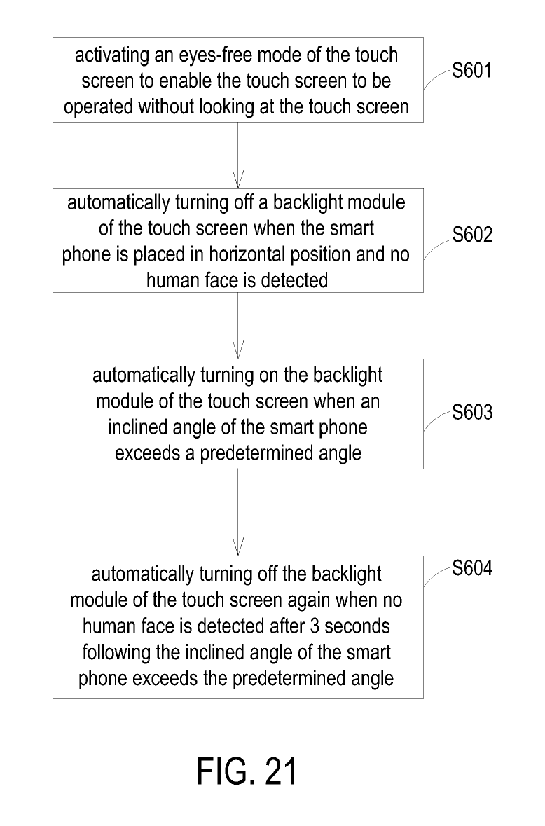

In an embodiment, as shown in FIG. 21, the method for controlling the backlight of the touch screen includes steps of: (a) activating an eyes-free mode of the touch screen to enable the touch screen to be operated without looking at the touch screen (S601); (b) automatically turning off the backlight module of the touch screen when the smart phone is placed in horizontal position and no human face is detected (S602); (c) automatically turning on the backlight module of the touch screen when an inclined angle of the smart phone reaches a predetermined angle (S603), and (d) automatically turning off the backlight module of the touch screen again when no human face is detected after 3 seconds following the inclined angle of the smart phone reaches the predetermined angle (S604). Certainly, the time lag can be varied according to different requirements, and it may be 2 to 5 seconds for instance.

From the above embodiments, the method for controlling the backlight of the touch screen is not limited to be applied to the remote control App, and can be applied to other Apps or operating functions that can run in an eyes-free mode. For example, when listening to music using a music player App, sometimes there is no need for the user to look at the touch screen because all the user needs is to input play/pause, and tune volume up/down and/or jump forward/backward. Thus, the music player App can be programmed to receive touch inputs such as: tuning volume up when the use's finger slides up on the touch screen; tuning volume down when the use's finger slides down on the touch screen; jumping forward when the use's finger slides right on the touch screen; jumping backward when the use's finger slides left on the touch screen; and inputting play or pause when the use's finger clicks on the touch screen. Therefore, the music player App can also be operated in an eyes-free mode, and thus can utilize the method of the present invention to save battery power.

Further, the major function keys for TV control are volume up/down and channel up/down, so the simple TV remote control App can be programmed to receive touch inputs such as: tuning volume up when the use's finger slides up on the touch screen; tuning volume down when the use's finger slides down on the touch screen; tuning channel up when the use's finger slides right on the touch screen; and tuning channel down when the use's finger slides left on the touch screen. Therefore, this kind of TV remote control App can also be operated in an eyes-free mode, and thus can utilize the method of the present invention to save battery power.

On the other hand, in addition to DISPLAY ON/OFF, the brightness of the touch screen can be fine tuned incrementally in accordance with the percentage of orientation/inclination detected. For example, when the touch screen is in 0 degree relative to the horizontal, the backlight module of the touch screen is completely turned off. When the touch screen is in 45 degree relative to the horizontal, the backlight module of the touch screen is completely turned on. While in between 0-45 degrees, the brightness of the touch screen is adjusted proportionally.

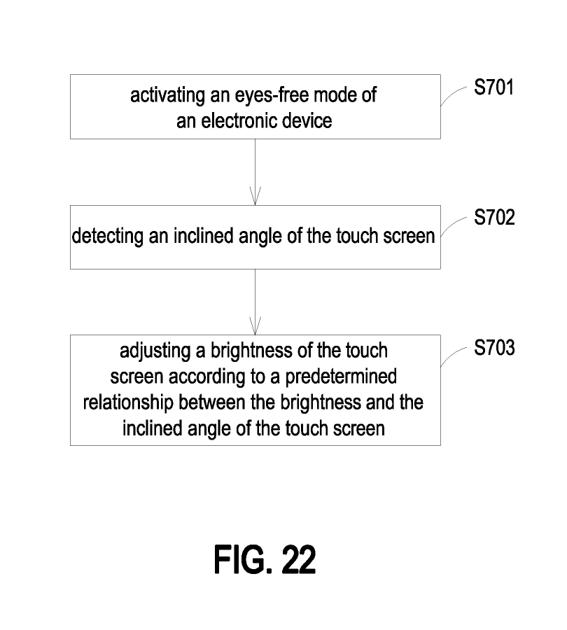

In an embodiment, as shown in FIG. 22, the method for controlling the backlight of the touch screen includes steps of: (a) activating an eyes-free mode of an electronic device (S701); (b) detecting an inclined angle of the touch screen (S702); and (c) adjusting the brightness of the touch screen according to a predetermined relationship between the brightness and the inclined angle of the touch screen (S703), such as in an incremental way.

Since the preferred brightness of the touch screen varies depending on different users, the brightness setting can also be customized and configured. For example, the relationship between the brightness of the touch screen and the user's face feature can be predetermined. Thus, in an embodiment, the method described in the preceding paragraph further includes steps of: detecting and identifying a face feature in front of the touch screen; and adjusting the brightness of the touch screen according to the predetermined relationship between the brightness of the touch screen and the face feature, or loading the customized settings corresponding to the identified face feature. Of course, the method also provides a tactile positioning device, such as the film including tactile units, on the touch screen so as to enable the electronic device to be operated in an eyes-free mode.

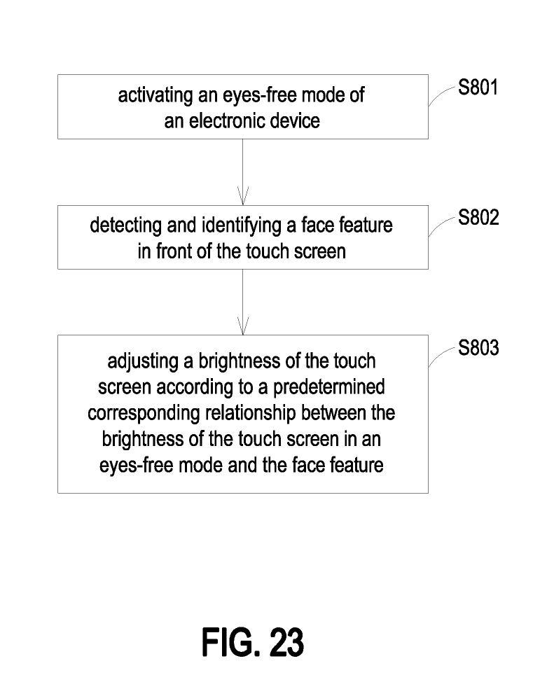

In an embodiment, as shown in FIG. 23, the method for controlling the backlight of the touch screen includes steps of: (a) activating an eyes-free mode of an electronic device (S801); (b) detecting and identifying a face feature in front of the touch screen (S802); and (c) adjusting the brightness of the touch screen according to the predetermined relationship between the brightness of the touch screen in an eyes-free mode and the face feature.

Similarly, the method further includes a step of loading the customized settings corresponding to the identified face feature, and a step of providing a tactile positioning device, such as the film including tactile units, on the touch screen so as to enable the electronic device to be operated in an eyes-free mode.

In conclusion, the present invention provides the tactile positioning device and the operating device having the tactile positioning device. The tactile positioning device includes the film which is attached to the touch surface of the portable electronic device and at least includes the first tactile unit and/or the second tactile unit, wherein the first tactile unit is corresponding to the major key on the touch surface, and the second tactile unit is the linear tactile unit for defining the operating route or range. Therefore, through the different tactile senses provided by the tactile units, the user can feel the position of the major key or the operating route or range when the user moves his/her finger on the touch surface. Therefore, the user can operate the operating device in an eyes-free mode, so as to have a more flexible utilization. On the other hand, the film of the present invention can be only attached to a partial range of the touch surface, and the edge of the film defines the operating route or range and provides tactile feedback to the user to feel the operating route or range. In addition, the tactile unit of the tactile positioning device can also be directly disposed on the touch surface of the portable electronic device without the use of the film.

Moreover, the present invention also provides the method for controlling the backlight of the touch screen. To save battery power, the method first activates an eyes-free mode of an electronic device, e.g. by providing the tactile positioning device on the touch screen, so the backlight module of the touch screen can be turned off, and the utilization status is dynamically detected so as to turn on or adjust the brightness of the backlight module of the touch screen when needed. According to the embodiments of the present invention, the backlight module of the touch screen is automatically turned off when the electronic device is placed in horizontal position and/or no human face is detected, and is automatically turned on when an inclined angle of the electronic device reaches a predetermined angle and/or a human face is detected. Therefore, the backlight module of the touch screen can be automatically turned off or turned on under the eyes-free mode so as to achieve the purpose of power saving.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A tactile positioning device for eyes-free operation of a touch surface of a portable electronic device, comprising:
a film attached to the touch surface of the portable electronic device, the film comprising:
at least a first tactile unit used as a positioning reference point of a key on the touch surface; and
at least a second tactile unit being a linear tactile unit for defining an operating route or an operating range;
wherein tactile feedbacks provided by the first tactile unit and the second tactile unit enable a user to sense a position of the key which is positioned by the first tactile unit and the operating route or the operating range defined by the second tactile unit, so as to operate the portable electronic device without having to look at the touch surface.

2. The tactile positioning device according to claim 1 wherein the film is optically clear, transparent or semi-transparent.

3. The tactile positioning device according to claim 1 wherein each of the first tactile unit and the second tactile unit is formed by a protrusion or an indentation, has uneven or irregular surface, or is formed by a material different from that of the other area of the film.

4. The tactile positioning device according to claim 1 wherein the second tactile unit is shaped as a line, a circle, a rectangle or a cross.

5. The tactile positioning device according to claim 1 wherein the film comprises a first layer, an adhesive layer and a second layer, and the adhesive layer sticks and combines the first layer and the second layer.

6. The tactile positioning device according to claim 5 wherein a bottom surface of the second layer is an even surface and is attached to the touch surface of the portable electronic device, and the first tactile unit and the second tactile unit are disposed on a top surface of the first layer.

7. The tactile positioning device according to claim 1 wherein the film is attached to a partial range of the touch surface.

8. The tactile positioning device according to claim 1 wherein the film comprises plural first tactile units used as positioning reference points of different keys on the touch surface, and the plural first tactile units have different shapes or forms to provide different tactile senses.

9. The tactile positioning device according to claim 1 wherein the film further includes at least a third tactile unit corresponding to an operating end of the key.

10. The tactile positioning device according to claim 1 wherein the film further includes at least a fourth tactile unit disposed on the operating route defined by the second tactile unit for providing positioning function on the operating route.

11. The tactile positioning device according to claim 1 wherein the touch surface is a touch screen or a touchpad.

12. An operating device for eyes-free operation comprising:
a portable electronic device having a touch surface; and
a tactile positioning device comprising at least a film attached to a partial range of the touch surface of the portable electronic device, the film comprising at least a first tactile unit used as a positioning reference point of a key on the touch surface, wherein an edge of the film defines an operating route or an operating range, and a tactile feedback provided by the first tactile unit enables a user to sense a position of the key which is positioned by the first tactile unit and a tactile feedback provided by the edge of the film enables the user to sense the operating route or the operating range defined by the edge of the film, so as to operate the portable electronic device without having to look at the touch surface.

13. An operating device for eyes-free operation having a touch surface for receiving a touch input, characterized in that:
a linear tactile unit corresponding to an operating route of the operating device is disposed on the touch surface.

14. The operating device according to claim 13, characterized in that:
at least a non-linear tactile unit is disposed on the touch surface, and the at least a non-linear tactile unit is corresponding to one selected from the group consisting of an end point, a neutral point and an equal division point on the operating route and combinations thereof.

15. The operating device according to claim 13, characterized in that:
the touch surface is a touchpad on a laptop computer, and the operating route is corresponding to a scrolling function of the laptop computer.

16. An operating method for eyes-free operation comprising steps of:
providing a tactile unit on a touch surface of an operating device, and the tactile unit being used as a positioning reference point of a key;
programming the operating device to not to respond to a finger search for the tactile unit on the touch surface; and
programming the operating device to respond to a touch operation on the key or surrounding keys after the tactile unit is positioned by the finger search.

17. The operating method according to claim 16 further comprising steps of:
detecting an inclined angle of the touch surface; and
adjusting a brightness of the touch surface according to a predetermined relationship between the brightness and the inclined angle of the touch surface.

18. The operating method according to claim 16 further comprising steps of:
detecting and identifying a face feature in front of the touch surface; and
adjusting a brightness of the touch surface according to a predetermined relationship between the brightness of the touch surface and the face feature.

19. The operating method according to claim 16 wherein the operating device is programmed to not to respond to the finger search with a contact time lasting over a predetermined time.

20. A method for controlling a backlight of a touch screen for an electronic device for eyes-free operation, comprising steps of:
activating an eyes-free mode of the electronic device;
detecting an inclined angle of the touch screen; and
adjusting a brightness of the touch screen according to a predetermined relationship between the brightness and the inclined angle of the touch screen.

21. The method for controlling the backlight of the touch screen according to claim 20 wherein the brightness of the touch screen is adjusted in an incremental way.

22. The method for controlling the backlight of the touch screen according to claim 20 further comprising steps of:
detecting and identifying a face feature in front of the touch screen; and
adjusting the brightness of the touch screen according to a predetermined relationship between the brightness of the touch screen in the eyes-free mode and the face feature.

23. The method for controlling the backlight of the touch screen according to claim 20 further comprising steps of:
detecting and identifying a face feature in front of the touch screen; and
loading customized settings corresponding to the identified face feature.

24. The method for controlling the backlight of the touch screen according to claim 20 further comprising a step of installing a remote control App to the electronic device.

25. The method for controlling the backlight of the touch screen according to claim 20 further comprising a step of providing a tactile positioning device on the touch screen for the eyes-free mode.

26. The method for controlling the backlight of the touch screen according to claim 25 wherein the tactile positioning device comprises a film attached to the touch screen of the electronic device, and the film comprises at least a first tactile unit used as a positioning reference point of a key on the touch screen.

27. The method for controlling the backlight of the touch screen according to claim 26, wherein the film further comprises at least a second tactile unit being a linear tactile unit for defining an operating route or an operating range.

28. The method for controlling the backlight of the touch screen according to claim 20 further comprising steps of:
automatically turning on the backlight of the touch screen when the inclined angle of the touch screen reaches a predetermined angle; and
automatically turning off the backlight of the touch screen again when no human face is detected after a predetermined time lag following the inclined angle of the touch screen reaches the predetermined angle.

29. A method for controlling a backlight of a touch screen for an electronic device for eyes-free operation, comprising steps of:
activating an eyes-free mode of the electronic device;
detecting and identifying a face feature in front of the touch screen; and
adjusting a brightness of the touch screen according to a predetermined relationship between the brightness of the touch screen in the eyes-free mode and the face feature.

30. The method for controlling the backlight of the touch screen according to claim 29 further comprising a step of loading customized settings corresponding to the identified face feature.

31. The method for controlling the backlight of the touch screen according to claim 29 further comprising a step of providing a tactile positioning device on the touch screen for the eyes-free mode.

32. The method for controlling the backlight of the touch screen according to claim 31 wherein the tactile positioning device comprises a film attached to the touch screen of the electronic device, and the film comprises at least a first tactile unit used as a positioning reference point of a key on the touch screen.

33. The method for controlling the backlight of the touch screen according to claim 32, wherein the film further comprises at least a second tactile unit being a linear tactile unit for defining an operating route or an operating range.
